(19) United States
(12) Patent Application Publication
(10) Pub. No.: US 2016/0288876 A1
(43) Pub. Date: Oct. 6, 2016

(54) DRIVE UNIT AND ELECTRIC STRADDLED VEHICLE INCLUDING THE SAME

(71) Applicant: YAMAHA HATSUDOKI KABUSHIKI KAISHA, Iwata-shi (JP)

(72) Inventor: Yuuichi YONEDA, Shizuoka (JP)

(21) Appl. No.: 15/086,477

(22) Filed: Mar. 31, 2016

(30) Foreign Application Priority Data
Apr. 1, 2015 (JP) 2015-074802

(51) Int. Cl. B62M 7/02; B62M 11/02; B62M 9/02

(52) U.S. Cl. CPC B62M 7/02; B62M 9/02; B62M 11/02; B62M 2701/0092; F16D 13/52

(57) ABSTRACT

A drive unit for use in an electric straddled vehicle provides high motor output while the size of the drive unit is kept from increasing. The drive unit includes a motor, a first gear, a rotation shaft, a second gear, and bearings. The motor includes a rotor shaft. The first gear is provided on the rotor shaft to rotate at a same speed as the rotor shaft. The rotation shaft is parallel or substantially parallel to the rotor shaft. The second gear is provided on the rotation shaft and meshes with the first gear. The bearings support the rotation shaft in a rotatable manner. The bearings at least partially overlap the motor when viewed in an axial direction of the rotation shaft.

### BACKGROUND OF THE INVENTION

1. Field of the Invention

The present invention relates to a drive unit for use in an electric straddled vehicle.

2. Description of the Related Art

An electric motorcycle is an example of an electric straddled vehicle. The electric motorcycle includes a drive unit. An example of a drive unit is disclosed, for example, in International Publication WO 2011/080790.

The above-described publication discloses a propulsion system for a motorcycle. The propulsion system includes a motor, a driving gear provided on a rotor shaft of the motor to rotate at the same speed as the rotor shaft, a driven shaft parallel to the rotor shaft, and a driven gear provided on the driven shaft and meshing with the driving gear to rotate the driven shaft.

A motor may have a large outer diameter in order to increase the output of the motor. An increase in the outer diameter of the motor results in an increased distance between a rotor shaft and a driven shaft. As the distance between the rotor shaft and the driven shaft increases, the driving gear and the driven gear must inevitably be increased in size in order to maintain a certain reduction gear ratio. The driven gear is adapted to have a larger diameter than that of the driving gear in order to obtain a desired reduction gear ratio. Therefore, if the distance between the rotor shaft and the driven shaft increases, the size of the driven gear becomes even larger. As a result, the size of the propulsion system is also increased.

### SUMMARY OF THE INVENTION

Preferred embodiments of the present invention provide a drive unit for use in an electric straddled vehicle having a high motor output while preventing the size of the drive unit from increasing.

The drive unit according to a preferred embodiment of the present invention is used in an electric straddled vehicle. The drive unit includes a motor, a first gear, a rotation shaft, a second gear, and a bearing. The motor includes a rotor shaft. The first gear is provided on the rotor shaft to rotate at the same speed as the rotor shaft. The rotation shaft is parallel or substantially parallel to the rotor shaft. The second gear is provided on the rotation shaft to mesh with the first gear. The bearing supports the rotation shaft in a rotatable manner. At least a portion of the bearing overlaps the motor when viewed in an axial direction of the rotation shaft.

In the drive unit described above, the rotation shaft is preferably provided close to the rotor shaft. Therefore, the second gear is prevented from having an increased diameter while a target reduction gear ratio is maintained. Moreover, the second gear is prevented from having an increased diameter so that the drive unit is prevented from increasing in size.

The motor may be an inner rotor type or an outer rotor type motor. As for the inner rotor type, only a portion of the bearing needs to overlap the stator when viewed in the axial direction of the rotation shaft. As for the outer rotor type, only a portion of the bearing needs to overlap the rotor when viewed in the axial direction of the rotation shaft.

The first gear rotates at the same speed as the rotor shaft, for example, when (1) the first gear is fixed to the rotor shaft, or (2) the rotor shaft is provided with a clutch and the first gear rotates integrally with the rotor shaft as the clutch is engaged. More specifically, the manner in which the first gear rotates at the same speed as the rotor shaft refers to the state in which the first gear rotates integrally with the rotor shaft. Stated differently, the manner in which the first gear rotates at the same speed as the rotor shaft refers to the state in which the first gear does not have its speed reduced relative to the rotor shaft.

Preferably, at least a portion of the rotation shaft overlaps the motor when viewed in the axial direction of the rotation shaft. In this way, the rotation shaft is arranged even closer to the rotor shaft. Therefore, an increase in the diameters of the first and second gears is prevented more easily while a target reduction gear ratio is maintained. In addition, the second gear is prevented from increasing in diameter more easily, so that an increase in the size of the drive unit is prevented more easily.

The drive unit as described above may further include a clutch. The clutch allows/prevents transmission of a driving force from the rotor shaft to the rotation shaft. The clutch is provided at an end of the rotation shaft. The end is spaced farther apart from the stator of the motor than from the second gear in the axial direction of the rotation shaft. The clutch includes an input. The input is spaced farther apart from the stator than from the rotation shaft in the axial direction of the rotation shaft. A force provided to operate the clutch acts on the input.

In this case, the input is spaced farther apart from the stator than from the rotation shaft in the axial direction of the rotation shaft, so that at least a portion of the rotation shaft overlaps the motor when viewed in the axial direction of the rotation shaft. Therefore, an increase in the diameter of the second gear is prevented even more easily. As a result, the size of the drive unit is prevented from increasing even more easily.

An electric straddled vehicle according to a preferred embodiment of the invention includes the above-described drive unit.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a left side view of an electric motorcycle according to a preferred embodiment of the present invention.

FIG. 2 is a sectional view of a drive unit provided in the electric motorcycle shown in FIG. 1.

FIG. 3 is a view for illustrating a positional relationship among a stator in a motor, a rotation shaft, and a bearing that supports the rotation shaft in a rotatable manner.

FIG. 4 is a partially enlarged view of FIG. 3.

FIG. 5 is a view illustrating another example of an operation mechanism for a clutch.

### DETAILED DESCRIPTION OF THE PREFERRED EMBODIMENTS

An electric straddled vehicle according to preferred embodiments of the present invention will be described in conjunction with the accompanying drawings. According to the preferred embodiments, an electric motorcycle will be described as an example of the electric straddled vehicle. In the drawings, the same or corresponding portions are designated by the same reference characters and their description will not be repeated.

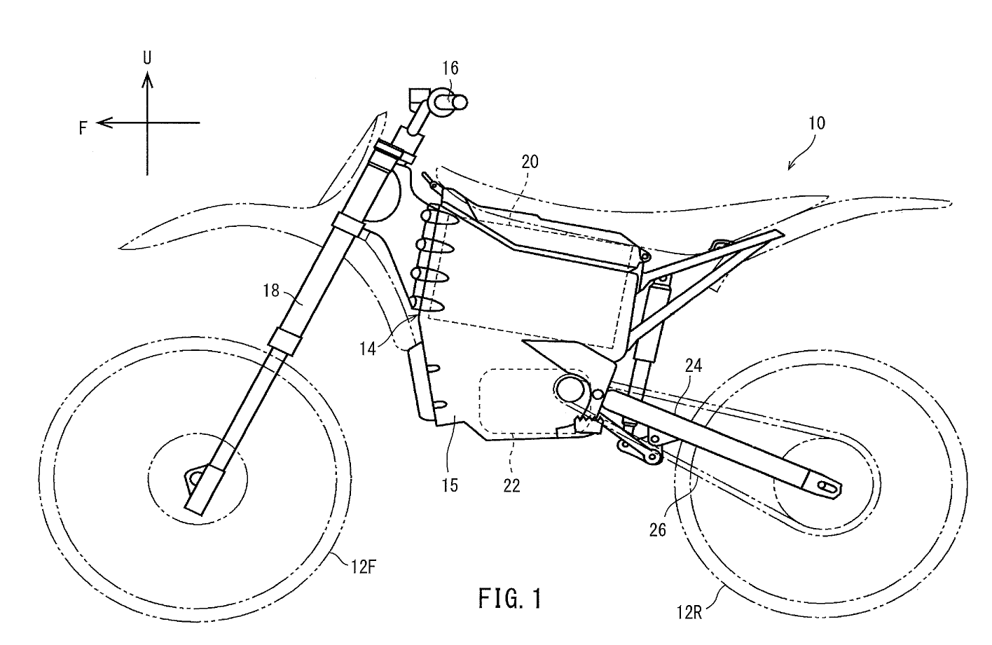

FIG. 1 is a left side view of an electric motorcycle 10 according to a preferred embodiment of the present invention. Note that the front, back, left, and right in the following description refer to these directions as viewed from a rider seated on a seat of the electric motorcycle 10. In FIG. 1, the arrow F designates a forward direction of the electric motorcycle 10 and the arrow U designates an upward direction of the electric motorcycle 10.

As shown in FIG. 1, the electric motorcycle 10 includes a front wheel 12F, a rear wheel 12R, a vehicle body frame 14, a handle 16, a front fork 18, a battery 20, a drive unit 22, a rear arm 24, and a chain 26.

The front fork 18 supports the front wheel 12F in a rotatable manner. The direction of the front wheel 12F is changed by operating the handle 16.

The vehicle body frame 14 supports the rear arm 24 in a swingable manner. The rear arm 24 supports the rear wheel 12R in a rotatable manner.

The vehicle body frame 14 includes a housing 15. The battery 20 and the drive unit 22 are provided in the housing 15. The drive unit 22 is positioned under the battery 20.

Electric power stored by the battery 20 is supplied to the drive unit 22 through a controller that is not shown. In this way, the drive unit 22 is driven.

Motive power from the drive unit 22 is transmitted to the rear wheel 12R through the chain 26. In this way, the rear wheel 12R is rotated.

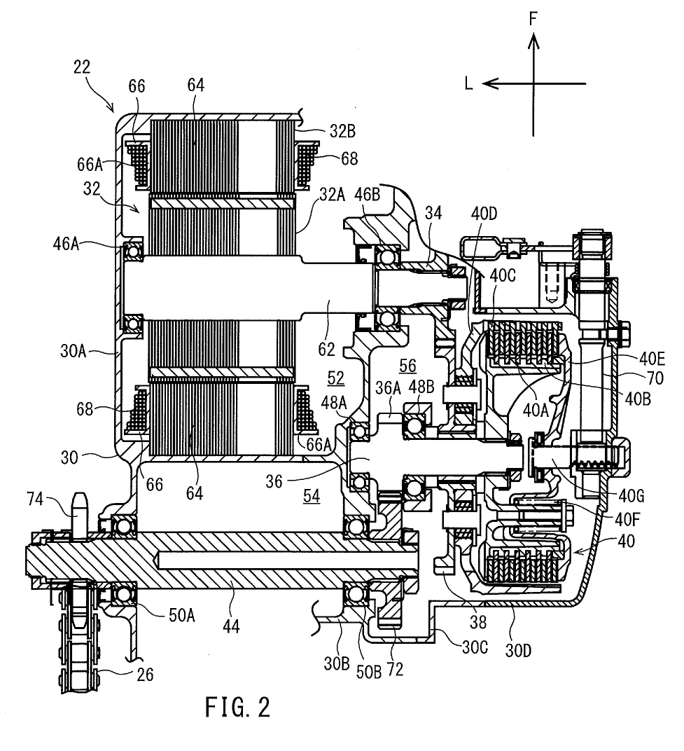

Referring to FIG. 2, the drive unit 22 will be described. FIG. 2 is a sectional view of the drive unit 22.

The drive unit 22 outputs motive power used to rotate the rear wheel 12R. The drive unit 22 includes a housing 30, a motor 32, a gear 34, a shaft 36, a gear 38, a clutch 40, a shaft 44, bearings 46A and 46B, bearings 48A and 48B, and bearings 50A and 50B.

The housing 30 includes a first housing 30A, a second housing 30B, a third housing 30C, and a fourth housing 30D. The first housing 30A, the second housing 30B, the third housing 30C, and the fourth housing 30D are arranged side by side in this order in a left-right direction.

The first housing 30A is assembled to the second housing 30B. Two spaces 52 and 54 are provided between the first housing 30A and the second housing 30B. The space 52 houses the motor 32. The space 54 houses a portion of the shaft 44.

The third housing 30C is assembled to the second housing 30B. The third housing 30C is provided on an opposite side to the first housing 30A with respect to the second housing 30B.

The fourth housing 30D is assembled to the third housing 30C. The fourth housing 30D is provided on an opposite side to the second housing 30B with respect to the third housing 30C.

The second housing 30B, the third housing 30C, and the fourth housing 30D define a space 56. The space 56 houses the clutch 40.

The motor 32 is preferably a three-phase induction motor. The motor 32 includes a rotor 32A and a stator 32B.

The rotor 32A includes a rotor shaft 62. The rotor shaft 62 extends in the left-right direction. The rotor shaft 62 is rotatably supported by the bearings 46A and 46B. The bearing 46A is provided in the first housing 30A. The bearing 46B is provided in the second housing 30B.

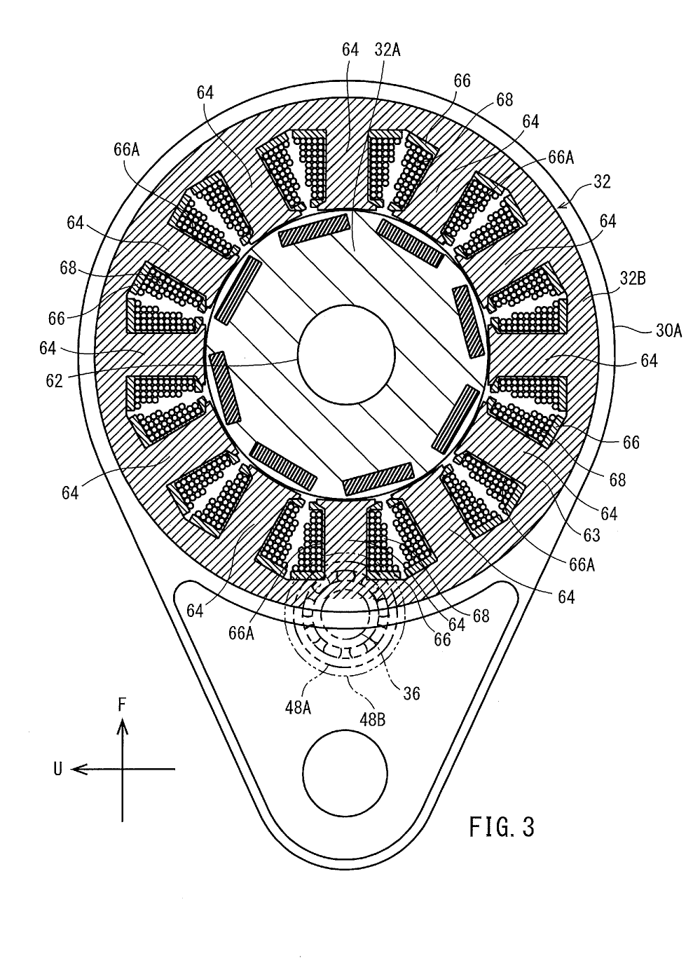

The stator 32B is provided around the rotor 32A. Referring to FIG. 3, the stator 32B will be described in detail. FIG. 3 is a view illustrating a positional relationship among the stator 32B, the shaft 36, and the bearings 48A and 48B when viewed from the right side of the vehicle.

The stator 32B includes an annular main body 63 and a plurality of (12 in the present preferred embodiment) cores 64. The main body 63 extends continuously in a circumferential direction around the rotor shaft 62. The plurality of cores 64 each project toward the rotor shaft 62 from the inner circumferential surface of the main body 63. The plurality of cores 64 are arranged at equal intervals in the circumferential direction around the rotor shaft 62. A coil bobbin 66 is assembled to each of the cores 64. The coil bobbin 66 includes a coil 68 wound therearound.

Referring back to FIG. 2, the gear 34 is fixed to the rotor shaft 32A. More specifically, the gear 34 rotates integrally with the rotor shaft 32A. Sated differently, the gear 34 rotates at the same speed as the rotor shaft 32A. The gear 34 is spaced farther apart from the stator 32B than from the bearing 46B in an axial direction of the rotor shaft 32A. In other words, the gear 34 is provided in the space 56.

The shaft 36 is provided in the space 56. The shaft 36 is rotatably supported by the bearings 48A and 48B. The bearing 48A is provided in the second housing 30B. The bearing 48B is provided in the third housing 30C.

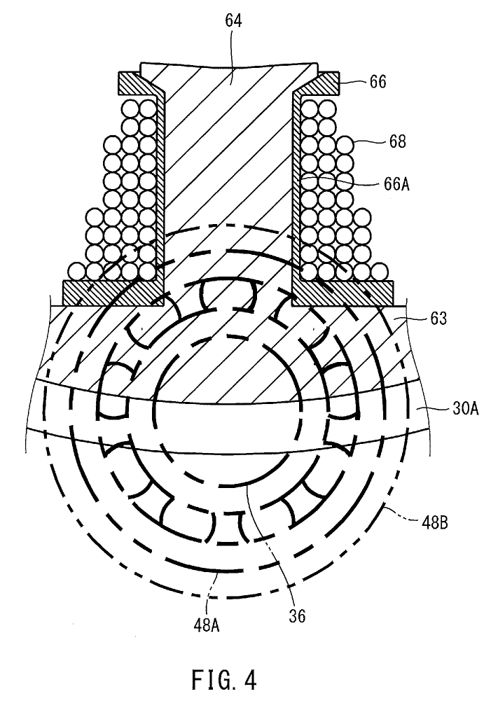

Referring to FIG. 4, the positional relationship among the stator 32B, the shaft 36, and the bearings 48A and 48B will be described in detail. FIG. 4 is a partially enlarged view of FIG. 3.

As can be seen in an axial direction of the shaft 36, a portion of the shaft 36 overlaps the main body 63 of the stator 32B. As can be seen in the above-described axial direction, the bearings 48A and 48B partially overlap one of the plurality of cores 64. As can be seen in the above-described axial direction, the bearings 48A and 48B partially overlap a coil bobbin 66 assembled to the above-described core 64. As can be seen in the above-described axial direction, the bearings 48A and 48B partially overlap a portion 66A of the coil bobbin 66 around which the coil 68 is wound. The portion 66A extends in the projecting direction of the core 64. In other words, the portion 66A surrounds the core 64.

Referring back to FIG. 2, the shaft 36 is provided with the gear 38. The gear 38 rotates integrally with the shaft 36 when the clutch 40 is engaged. When the clutch 40 is disengaged, the gear 38 is rotatable relative to the shaft 36. The gear 38 meshes with the gear 34. The gear 38 has a larger diameter than that of the gear 34. The gear 38 is spaced farther apart from the bearing 48A than from the bearing 48B in the axial direction of the shaft 36. The gear 38 overlaps the shaft 44 as seen in the above-described axial direction.

The shaft 36 is provided with the clutch 40. The clutch 40 is provided at an end of the shaft 36 that is spaced farther apart from the bearings 48A and 48B than from the gear 38 in the axial direction of the shaft 36. The clutch 40 overlaps the bearings 46A and 46B as seen in the above-described axial direction.

The clutch 40 includes a plurality of friction plates 40A, a clutch boss 40B, a plurality of clutch plates 40C, a clutch housing 40D, a pressure plate 40E, a clutch spring 40F, and a rod 40G. The clutch boss 40B is fixed to the shaft 36 to support the plurality of friction plates 40A. The clutch housing 40D is fixed to the gear 38 to support the plurality of clutch plates 40C. The rod 40G is coupled to the pressure plate 40E and includes a rack that engages with a pinion on a rod 70 positioned near the clutch 40. The rod 40G moves the pressure plate 40E against the energizing force of the clutch spring 40F as the rod 70 rotates. The rod 40G is spaced farther apart from the gear 38 than from the shaft 36 in the axial direction of the shaft 36. Transmission of a motive power from the gear 38 to the shaft 36 is allowed/prevented in response to a position of the pressure plate 40E. According to the present preferred embodiment, an operation mechanism for the clutch 40 includes the rods 40G and 70. The clutch 40 may have a known structure and therefore will not be described in detail.

A gear 36A is fixed to the shaft 36. The gear 36A is positioned between the bearings 48A and 48B in the axial direction of the shaft 36. The gear 36A has a smaller diameter than that of the gear 38.

The shaft 44 is rotatably supported by the bearings 50A and 50B. The bearing 50A is provided in the first housing 30A. The bearing 50B is provided in the second housing 30B.

A gear 72 is fixed to the shaft 44. The gear 72 rotates integrally with the shaft 44. The gear 72 is spaced farther apart from the bearing 50A than from the bearing 50B. The gear 72 is provided in the space 56. The gear 72 meshes with the gear 38. The gear 72 has a larger diameter than that of the gear 36A.

A sprocket 74 is fixed to the shaft 44. The sprocket 74 rotates integrally with the shaft 44. The sprocket 74 is spaced farther apart from the bearing 50B than from the bearing 50A in an axial direction of the shaft 44. The sprocket 74 is positioned outside the housing 30. The sprocket 74 has the chain 26 wound therearound.

In the electric motorcycle 10, the output of the motor 32 is increased while the drive unit 22 is prevented from increasing in size. This is achieved due to the following reasons.

The motor 32 may have a large outer diameter in order to increase the output of the motor 32. When the motor 32 has a large diameter, the distance between the rotor shaft 62 and the shaft 36 increases. The increase in the distance between the rotor shaft 62 and the shaft 36 inevitably increases the diameter of the gear 34 provided on the rotor shaft 62 and the diameter of the gear 38 provided on the shaft 36. The gear 38 has a larger diameter than that of the gear 34 in order to obtain a desired reduction gear ratio. Therefore, the increase in the distance between the rotor shaft 62 and the shaft 36 results in a further increase in the size of the gear 38. This could increase the size of the drive unit 22 as a result.

In the electric motorcycle 10, the bearings 48A and 48B partially overlap the stator 32B when viewed in the axial direction of the shaft 36. Therefore, the distance between the rotor shaft 62 and the shaft 36 is reduced. This allows a target reduction gear ratio to be obtained while the gear 38 is prevented from further increasing in size. Moreover, since this prevents the gear 38 from further increasing in size, the size of drive unit 22 is prevented from increasing.

In the electric motorcycle 10, the bearings 48A and 48B partially overlap one of the plurality of cores 64 when viewed in the axial direction of the shaft 36. Therefore, the distance between the rotor shaft 62 and the shaft 36 is even shorter.

In the electric motorcycle 10, the bearings 48A and 48B partially overlap a coil bobbin 66 assembled to one of the plurality of cores 64 when viewed in the axial direction of the shaft 36. Therefore, the distance between the rotor shaft 62 and the shaft 36 is even shorter.

In the electric motorcycle 10, the bearings 48A and 48B partially overlap a portion 66A of the coil bobbin 66 assembled to one of the plurality of cores 64 that has the coil 68 wound therearound when viewed in the axial direction of the shaft 36. This allows the distance between the rotor shaft 62 and the shaft 36 to be even shorter.

In the electric motorcycle 10, the shaft 36 partially overlaps the main body 63 of the stator 32B when viewed in the axial direction of the shaft 36. This allows the distance of the rotor shaft 62 and the shaft 36 to be even shorter.

In the electric motorcycle 10, the shaft 36 partially overlaps the main body 63 of the stator 32B when viewed in the axial direction of the shaft 36. This allows the length of the shaft 36 to be shortened. The weight of the shaft 36 is reduced as a result. More specifically, the drive unit 22 has a reduced weight.

In the electric motorcycle 10, since the drive unit 22 includes the clutch 40, the transmission of a driving force from the motor 32 to the shaft 44 is allowed or prevented. Therefore, transmission of the driving force from the motor 32 to the shaft 44 is allowed or prevented based on the rider's intention. As a result, the vehicle is able to be switched from a state in which driving force from the motor 32 is not transmitted to the shaft 44 to a state in which the driving force is transmitted, for example, when the electric motorcycle 10 starts, so that a maneuver in which the front wheel of the motorcycle comes off from the ground while riding (e.g., a Wheelie) is possible. More specifically, in the electric motorcycle 10, the performance of the electric motorcycle 10 is improved since the drive unit 22 includes the clutch 40.

In the electric motorcycle 10, the clutch 40 includes the rod 40G. The rod 40G is operated by the rod 70. The rod 70 is spaced farther apart from the motor 32 than from the clutch 40 in the axial direction of the shaft 36. A push rod does not have to be provided through the shaft 36 in order to operate the clutch, and therefore the shaft 36 is able to be shortened. Therefore, the shaft 36 is positioned to partially overlap the core 64 when viewed in the axial direction of the shaft 36. In other words, the distance between the rotor shaft 62 and the shaft 36 is shortened.

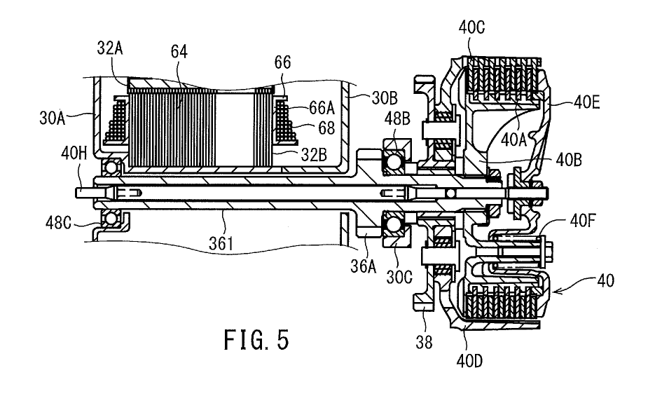

In the above-described preferred embodiments, the rod 40G is operated by the rod 70 in order to operate the clutch 40 while the clutch 40 may be operated, for example, by an operation mechanism shown in FIG. 5.

In the example shown in FIG. 5, a tubular shaft 361 is provided instead of the shaft 36. The shaft 361 is rotatably supported by bearings 48B and 48C. More specifically, in the example shown in FIG. 5, the bearing 48C is provided instead of the bearing 48A. The bearing 48C is supported by the first housing 30A.

In the example shown in FIG. 5, a rod 40H is provided instead of the rod 40G. The rod 40H is provided through the shaft 361 and coupled to the pressure plate 40E. As the rod 40H is operated by a clutch release mechanism (not shown) disposed outside the housing 30, the clutch 40 is operated. The clutch release mechanism is, for example, a hydraulic cylinder. In the example shown in FIG. 5, the operation mechanism for the clutch 40 includes the rod 40H and the clutch release mechanism (not shown).

In the example shown in FIG. 5, the bearings 48B and 48C that support the shaft 361 in a rotatable manner overlap the stator 32B when viewed in an axial direction of the shaft 361. Therefore, the distance between the shaft 361 and the rotor shaft 62 is shortened.

The preferred embodiments of the present invention have been described but are only exemplary illustrations of how the present invention may be carried out. Therefore, the present invention is not limited by the above description of the preferred embodiments, and modifications may be made to the above-described preferred embodiments without departing the scope of the present invention.

In the above-described preferred embodiments, the drive unit 22 preferably includes the clutch 40, but the drive unit does not have to include the clutch.

In the above-described preferred embodiments, the clutch 40 is preferably provided on the shaft 36, but the clutch may be provided, for example, on the rotor shaft.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A drive unit for use in an electric straddled vehicle, the drive unit comprising:
a motor including a rotor shaft;
a first gear on the rotor shaft that rotates at a same speed as the rotor shaft;
a rotation shaft parallel or substantially parallel to the rotor shaft;
a second gear on the rotation shaft that meshes with the first gear; and
a bearing that supports the rotation shaft in a rotatable manner and at least partially overlaps the motor when viewed in an axial direction of the rotation shaft.

2. The drive unit according to claim 1, wherein at least a portion of the rotation shaft overlaps the motor when viewed in the axial direction of the rotation shaft.

3. The drive unit according to claim 1, wherein the bearing includes a first bearing provided closer to the second gear than to a stator of the motor in the axial direction of the rotation shaft.

4. The drive unit according to claim 3, wherein the bearing further includes a second bearing provided closer to the second gear than to the first bearing in the axial direction of the rotation shaft.

5. The drive unit according to claim 3, wherein the bearing further includes a second bearing spaced farther apart from the second gear than from the stator in the axial direction of the rotation shaft.

6. The drive unit according to claim 1, further comprising a clutch provided at an end of the rotation shaft and spaced farther apart from the stator of the motor than from the second gear in the axial direction, the clutch selectively allowing and preventing transmission of a driving force from the rotor shaft to the rotation shaft; wherein
the clutch including an input which is spaced farther apart from the stator than from the rotation shaft in the axial direction of the rotation shaft and on which a force operating the clutch acts.

7. An electric straddled vehicle comprising the drive unit according to claim 1.
